(19) United States
(12) Patent Application Publication
(10) Pub. No.: US 2010/0310815 A1
(43) Pub. Date: Dec. 9, 2010

(54) PLASTIC DEFORMATION TECHNOLOGICAL PROCESS FOR PRODUCTION OF THIN WALL REVOLUTION SHELLS FROM TUBULAR BILLETS

(75) Inventors: Luis Manuel Mendonca Alves, Corroios (PT); Paulo Antonio Firme Martins, Belas (PT); Tiago Da Costal Duarte Pardal, Lisboa (PT); Paulo Jorge Correira De Almeida, Sobreda Caparica (PT); Nuno Miguel Pereira Dos Anjos Valverde, Odivelas (PT)

Correspondence Address: SUGHRUE MION, PLLC, 2100 PENNSYLVANIA AVENUE, N.W., SUITE 800, WASHINGTON, DC, 20037, US

(73) Assignee: OMNIDEA, LDA., Viseu (PT)

(21) Appl. No.: 12/865,656

(22) PCT Filed: Jan. 30, 2009
(86) PCT No.: PCT/PT09/00007

§ 371 Date: Jul. 30, 2010

(30) Foreign Application Priority Data
Feb. 1, 2008 (PT) 103953
Aug. 11, 2008 (PT) 104159

(51) Int. Cl. B21D 51/08; B21D 51/24; B32B 3/06

(52) U.S. Cl. 428/99; 72/379.4

(57) ABSTRACT

This invention refers to a process of plastic deformation for production of thin wall revolution shells from tubular billets. The process consists in end-forming a hollow circular section billet, which can be composed of a multi- layered assembly, by using sharp edge internal domed shaped molds (1) that are guided externally by a constraining sleeve (3). This mold-sleeve tool can be assembled in a press in order to generate the pressure forces necessary for the forming process. The plastic deformation can result in thin walled spheres or cylinders with domed ends. The resultant revolution shells have two opposite (polar) circular openings. Both the shell's length as the polar hole diameter is mainly determined by the billet's initial dimensions and mold (1) domed geometry. An innovative flexible inner mandrel may be introduced to considerably improve overall shell characteristics, allowing reduction of shell polar opening diameter, giving control of along-meridian thickness, solving typical thin wall forming problems such as buckling, wrinkling and ruptures and improve both outer and inner surface quality. This mandrel can be discarded and/or recycled after forming. This invention enables a low-cost and high-rate process for production of structural revolution shells capable of being used as high-pressure vessels.

### TECHNICAL DOMAIN

Thin walled revolution shells of spherical or cylindrical shape have many applications in several areas of engineering.

Small hollow spheres, of diameters ranging 1-10 mm, are being used in the manufacture of energy-absorbing, sonic and thermal insulation structures, among other applications. Larger diameter spheres or tubular vessels of sizes up to several meters are used in domestic and industrial pressure reservoirs, silos for bulk storage and many more. Even in decorative and architectural purposes there is a vast potential for these revolution shells, as several materials can be employed and even used together in the forming process, allowing an innumerous combinations of shape, colors and finishing possibilities.

Spherical shells and tubular shapes are also usually used as structural links for spatial reticular structures, raging from a small toy to multi-shaped buildings and structures. Some high-end applications of these structures are space station components and movable robotic structures as they are easily transported and assembled into multi-shaped structural modules.

In transportation (storage and propulsion), pressure reservoirs applications for gases or liquids usually recur to tubular or spherical shells as they are structurally optimized shapes.

The potential for applications of spherical shells is crippled by the economical and technological limitations of the fabrication of these shapes. Any conventional process for forming thin walled shells deals with formability problems such as mechanical (forming) and thermal limitations for materials used, cost of tools and molds, energetical and time requirements. Two specific problems of manufacturing these shells are low repeatability (due to fabrication defects) and low rate of production (due to the complexity of the technological process involved).

This invention pretends to overcome most of the constrainments of technical and economical referred, by innovating in a forming process capable of providing high-rate production of thin walled revolution shells, obtained from tubular billets of any diameter. These shells can be obtained in a single forming stroke and aim from small to medium size production.

The shape obtained by this process is characterized by having a regular geometry, controllable thickness distribution, good overall surface quality and excellent structural integrity. The process allows production of variable length and/or thickness shells for a single diameter in a single tool assembly. The process has very-high resistance or even eliminates the typical forming problems such as instability and wrinkling.

In comparison to the actual used processes for manufacturing revolution shells, two of the main advantages are that this forming process does not require extensive machining or welding. This is a considerable improvement in reducing cost and manufacturing time, but also leads to a high reliable structural component as it reduces or eliminates failure possibilities. For instance, the most occurring failure for existent pressure vessels are leaks and ruptures near the welded joints that are currently required to join the several shells that compose the final structure. In this process, the resultant shell is a single part, obtained in single stroke and preserves billet's material properties throughout the process.

As stated above, eliminating the need for welded joints in manufacturing a closed shell also allows the possibility of using non-weldable materials that have better mechanical properties that those commonly used. A clear example is the possibility of forming shells with 7 series high-strength aluminium for pressure vessels. Also, material's thickness limitations for weldable joints can limit welded shell thickness. This process enables forming billets of thicknesses below 1 mm with diameter to thickness ratios higher than 70 and polar openings of sizes below a tenth of the billet's initial diameter thus allowing the production of very thin wall structural shells.

Considering the use of a shell with two or more layered materials was compromised with the manufacturing ability to enclose the inner shell with the outer material. For instance, using an inner polymeric shell (to provide sealing in a gas tank) demands that the outer shell cannot be metallic as no welding can be applied. This demands costly and time consuming techniques such as composite fiber overwrapping to provide structural integrity to the multi-layered shell. This forming process allows manufacturing shells from two or more layered materials. The formable materials are radially stacked in the billet and are formed in the shell's shape in a single operation. Several distinct layered shells and materials can be used and combinations of polymeric inner liners with metallic outer shells are now possible.

Besides reducing and eliminating forming problems, the introduction of the flexible mandrel allowed a precise control of shell's thickness distribution. For instance thickness can be kept to a minimum design requirement for the entire shell but allowing a local reinforcement, for instance, near the two polar openings. The complexity of the resultant structure was only possible to obtain, previously, in high-time and cost consuming machining processes that also required welding for obtaining a closed shell as mentioned above.

This means that the following described process is capable of answering to demanding design requirements without escalating the production cost or compromising shell's structural integrity.

### PRIOR ART

Of the prior art known to the applicant, the most relevant documents are patent applications GB 1127825 A, RU 2211106 C1 and RU 2157290 C2, and the article “Nosing of thin-walled hollow spheres using a die: experimental and theoretical investigation”, Alves, L. M. et al., 1 Aug. 2007, International Journal of Mechanics and Materials in Design, Vol. 3, No. 4, pp. 337-346.

The GB 1127825 A is an invention of a tool capable of producing spheroid objects by forming, but doesn't comprise either sharp edge molds neither a guiding sleeve as it is an open dies tool. The final shape is very limited in terms of forming scope and possible geometries. It intends to produce spheroidal objects with large openings to be applied as cross-like structural links between rods.

The RU 2211106 C1 refers to a forming process of forming hollow spherical metallic envelops, with large openings, capable of being used as ball type hydraulic taps. The invention is similar to the one previously described as it uses two open half-spherical dies and doesn't comprise any kind of external guidance by a sleeve. In order to shape the large openings for the spherical object, it recurs to a smaller diameter tube, placed inside the formable billet but that does not suffer any displacement from the process and is only joined to the outer shell in its edges. The invention also refers the possibility of forming a laminated metallic shell.

The RU 2157290 C2 refers to a method for making spherical products with through tubular duct. This duct remains undeformed during forming and it is only joined to the outer shell in its edges. The outer shell is composed of a rolled plate with an along axis welded joint on the overlapped material, which additionally forms a thickened portion of the wall that can be used to make grooves. Despite the overlapped region, billet is single layered and no kind of internal support is used while forming.

The published article “Nosing of thin-walled hollow spheres using a die: experimental and theoretical investigation” includes authors of the present invention and describes preliminary works done for the proposed application. Such work was done by using an open dies with several constraining rings in a multi-stroke assembly tool, requiring several steps to form a single sphere. There was no control over final wall thickness and the process suffers from typical forming problems, such as wrinkling and instability.

### DESCRIPTION OF THE INVENTION

The following invention regards the production of thin wall revolution shells obtained by a plastic deformation process. Shells geometry can be domed (of which spherical is an example), or cylindrical with domed shapes and are formed in:
i) a single stroke from tubular billets using two opposite movable domed molds guided by a constraining sleeve;
ii) a two-stage process where the billet is deformed using an inner domed mold tool and two different pushing tools: the first that supports the billet from the inside, providing a constrain support to the undeformed billet's region and the second that has a sharp edge dome geometry to provide full support to the previously deformed billet's region after its inversion inside the sleeve that constrains the entire process.

Tool's active components are: movable domed molds with sharp edges, fixed domed mold, a pushing tool to induce billet displacement while constraining its deformation and a guiding sleeve to provide a precise alignment between the previous. Any of these components can be easily mounted on a mechanical or hydraulic press with one or two independent axial translations in such a way to become a typical forming tool. During closure, the molds, guided by the sleeve, form the billet into a shell in one or two independent strokes. If the billet is short enough, upon total closure of the molds, the shell acquires a completely domed shape, for instance an entirely spherical shape. If the billet is longer, the final form is a cylindrical with domed shapes ending the shell.

An additional innovation is the usage of a flexible mandrel that provides an internal support in the billet, while forming. This mandrel is made from a material which has, simultaneously, good formability and lower mechanical resistance than the material that forms the shell. Geometrical parameters such as thickness, section profile and profile variations (along mandrel's axis) allow controlling the plastic deformation of the billet. This enables an effective on-demand control over the thickness and its variations along the revolution shell's axis.

The mandrel can be removed from the shell, using an adequate chemical, thermal or mechanical process. Though each billet requires a single mandrel, if its material and removal method is chosen accordingly, it can be recycled and reused to form another billet.

A billet, composed from radially stacked materials, can be employed in order to obtain a multi-layered shell. As previously, the inner material can act as an internal mandrel but remains inside the shell, acting like an active part of the structure. If the inner material cannot act as a mandrel, a mandrel is employed as above, being removed after forming with such a process that doesn't affect any of shell's layered materials.

The manufactured shell remains with two circular openings. The tool is capable of providing holes of any design specification, raging from large openings to very small sized (relative to the shell diameter).

Shell's openings can be machined and closed by several methods. For instance, rectified holes can be rapidly closed by commercially available rivet-nuts, providing a strong mechanical link. Furthermore, in case needed, a sealant such as a polymeric o-ring can be adapted to provide a closed pressure reservoir.

### BRIEF DESCRIPTION OF THE DRAWINGS

The description hereunder is based on the drawings attached hereto, which represent without any restrictive character:

FIG. 1, a cut-away view of the single stroke forming tool;

FIGS. 2 an 3, a cut-away view of the two phased forming tool; and

FIG. 4 shows a detail from the cut-away view of the polar region of a shell (5).

### DETAILED DESCRIPTION

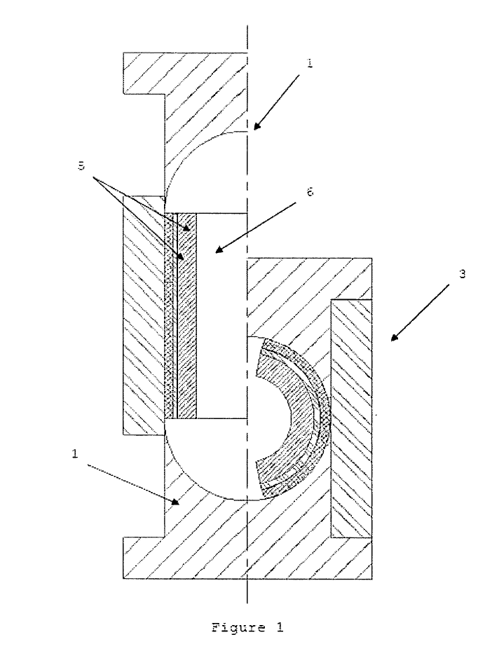

As may be observed, FIG. 1 is a cut-away view of the single stroke forming tool, were the active components are schematically represented in two different positions divided by an axial symmetry line: before closure (left) with billet and mandrel prior to forming and fully closed (right) with the final shell shape. The components are identified with numbers according to:
(1) are the inner domed molds with sharp edges that give the billet (5) the domed shape;
(3) is the guiding sleeve that: provides proper alignment between the molds (1); gives mechanical strength to the tool preventing damage to the sharp edges; constrains the single or multi-layer billet (5) in the tool and eliminates the possibility of the billet (5) forming outside the pretended shape. This sleeve (3) is axially free from the molds (1) and can or not be mechanically linked to the press;
(6) is the flexible mandrel, made of a material with good formability and lower than the billet's (5) mechanical strength. This mandrel supports the forming process from inside the billet (5), giving control over the thickness distribution for the formed shell, helping to greatly minimize the shell's polar openings and reduces or eliminates typical forming problems such as wrinkling, instability, cracks and fissures while providing better overall surface quality.

FIGS. 2 an 3 are a cut-away view of the two phased forming tool, where the active components are schematically represented in two different positions divided by an axial symmetry line: before closure (left) with single or multi-layer billet prior to forming and fully closed (right) with the final shell shape. The components are identified with numbers according to:
(2) is the fixed inner domed shape mold that forms the billet into its shell shape (5);
(4) is the first pushing tool that presses the billet (5) against the fixed mold (1) and supports the billet's inner surface in order to prevent deformation where it shouldn't occur.
(1) is the second pushing tool wherein its shape is a sharp edge inner domed mold that fully supports the already formed billet (5) region.

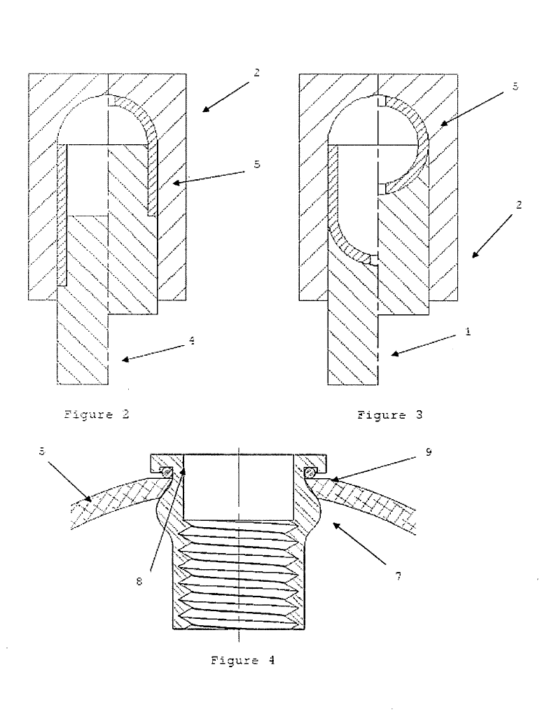

FIG. 4 shows a detail from the cut-away view of the polar region of a shell (5). The hole is closed with a rivet-nut (7), where a groove (8) is machined and an o-ring sealant (9) is added to represent an effective high-pressure vessel or a mechanical link for a reticulated structure.

1. Plastic deformation technological process for the fabrication of thin wall revolution shells from tubular billets comprising sharp edged inner domed molds (1) and a constraining guiding sleeve (3) wherein the billets (5) are composed by multi-layered and radially stacked elements of which, the innermost one is a internal flexible mandrel, with variable along axis thickness profile (6).

2. Plastic deformation technological process for the fabrication of thin wall revolution shells from tubular billets according to claim 1 wherein the shell is obtained in a single stroke by pressing in opposite directions two inverted sharp edged inner domed molds (1) inside a constraining guiding sleeve (3).

3. Plastic deformation technological process for the fabrication of thin wall revolution shells from tubular billets, according to claims 1 and 2, wherein the guiding sleeve (3) is only concentrically constrained to the inner domed molds, being free from press tool assembly and thus unconstrained of axial translations and/or rotations while forming.

4. Plastic deformation technological process for the fabrication of thin wall revolution shells from tubular billets, according to claim 1, wherein the forming tool is composed by a non-movable inner shaped domed mold (2), two different pushing tools (4) and (1) and where the billet (5) is formed into a revolution shell in a two-stage operation:
in the first stroke, half of the shell's (5) geometry is achieved by pressing the billet (5) with a displacement equal to the domed shape center-to-pole length using a pushing tool (4) that supports the material and constrains the inner surface to prevent deformation of the undeformed length;
the other dome is achieved in a second stroke by inverting the billet (5) in the mold and then pressing it again using a pushing tool (1) that has the same domed shaped inner geometry, with sharp edges, providing a complete support for the already formed half-shell (5).

5. Plastic deformation technological process for the fabrication of thin wall revolution shells from tubular billets, according to claim 1, composed by radially stacked materials, formed together, wherein the outer shell encloses the inner layers, providing a combination of different material properties into a final shape which is a composite layered material shell.

6. Plastic deformation technological process for the fabrication of thin wall revolution shells from tubular billets, according to claim 1, wherein the internal flexible mandrel is of a discardable type and is removed after forming by a combination of one or more of the following:
A thermal process if made of a material with a lower melting point than the shell's composition;
A combustion process wherein the mandrel is oxidized;
A chemical process using a solvent that only dissolves the mandrel and not the shell's material;
A mechanical process in which, by accessing through the polar openings, the mandrel material is machined and/or brushed from the shell's interior volume.

7. Shells obtained with the plastic deformation process of fabrication thin wall revolution shells from tubular billets, according to claim 1, which are closed by machining and rectifying the shells (5) openings and employing commercially available rivet-nuts (7) wherein a groove (8) is machined in the rivet's (7) bottom head in order to provide a face seal joint by using a circular sealant (9).

8. Plastic deformation technological process for the fabrication of thin wall revolution shells from tubular billets, according to claim 2, wherein the guiding sleeve (3) is only concentrically constrained to the inner domed molds, being free from press tool assembly and thus unconstrained of axial translations and/or rotations while forming
